(19) United States
(12) Patent Application Publication
(10) Pub. No.: US 2018/0009376 A1
(43) Pub. Date: Jan. 11, 2018

(54) CHILD VEHICLE OCCUPANCY WARNING SYSTEM

(71) Applicant: Cammy Johnson, Rushford, MN (US)

(72) Inventor: Cammy Johnson, Rushford, MN (US)

(21) Appl. No.: 15/205,751

(22) Filed: Jul. 8, 2016

(51) Int. Cl. B60Q 9/00

(52) U.S. Cl. CPC B60Q 9/00

(57) ABSTRACT

A child vehicle occupancy warning system includes comprising a pressure sensor for detecting a weight being positioned on a child car seat. A transmitter is electrically coupled to the pressure sensor. A key fob includes a fob housing, a fob processor, and a fob transceiver. A base unit is positioned on a dashboard of a vehicle and includes a base housing, a base processor mounted in the base housing and a base transceiver for receiving wireless signals from the transmitter and sending and receiving signals with the fob transceiver. The base processor determines when the fob transceiver is beyond a predetermined distance from the base unit. A warning light emitter is electrically coupled to the base transceiver. The base processor turns on the warning light emitter when a weight detection signal is received by the base transceiver and the fob transceiver is beyond the predetermined distance.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art including information disclosed under 37 CFR 1.97 and 1.98

The disclosure and prior art relates to unattended child warning devices and more particularly pertains to a new unattended child warning device for preventing a caregiver from unintentionally leaving a child unattended within a vehicle.

### (h) BRIEF SUMMARY OF THE INVENTION

An embodiment of the disclosure meets the needs presented above by generally comprising a pressure sensor configured for detecting a weight positioned thereon wherein the pressure sensor is configured to be positioned on a child car seat and detect the weight of a child on the child car seat. A transmitter is electrically coupled to the pressure sensor and sends a weight detection signal when the pressure sensor detects the weight on the child car seat. A key fob includes a fob housing, a fob processor, and a fob transceiver mounted in the fob housing and electrically coupled to the fob processor. A base unit is configured for being positioned on a dashboard of a vehicle. The base unit includes a base housing, a base processor mounted in the base housing and a base transceiver for receiving wireless signals from the transmitter and sending and receiving signals with the fob transceiver. The base transceiver is positioned in the base housing and electrically coupled to the base processor. The base processor determines when the fob transceiver is beyond a predetermined distance from the base unit. A warning light emitter is electrically coupled to the base transceiver and is mounted on the base housing. The base processor turns on the warning light emitter when the weight detection signal is received by the base transceiver and the fob transceiver is beyond the predetermined distance.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a child vehicle occupancy warning system according to an embodiment of the disclosure.

FIG. 2 is an in-use front perspective view of an embodiment of the disclosure.

FIG. 3 is a front view of an embodiment of the disclosure.

FIG. 4 is a schematic view of an embodiment of the disclosure.

FIG. 5 is a flow chart of an embodiment of a fob unit of the disclosure.

FIG. 6 is a flow chart of an embodiment of a base unit the disclosure.

### (j) DETAILED DESCRIPTION OF THE INVENTION

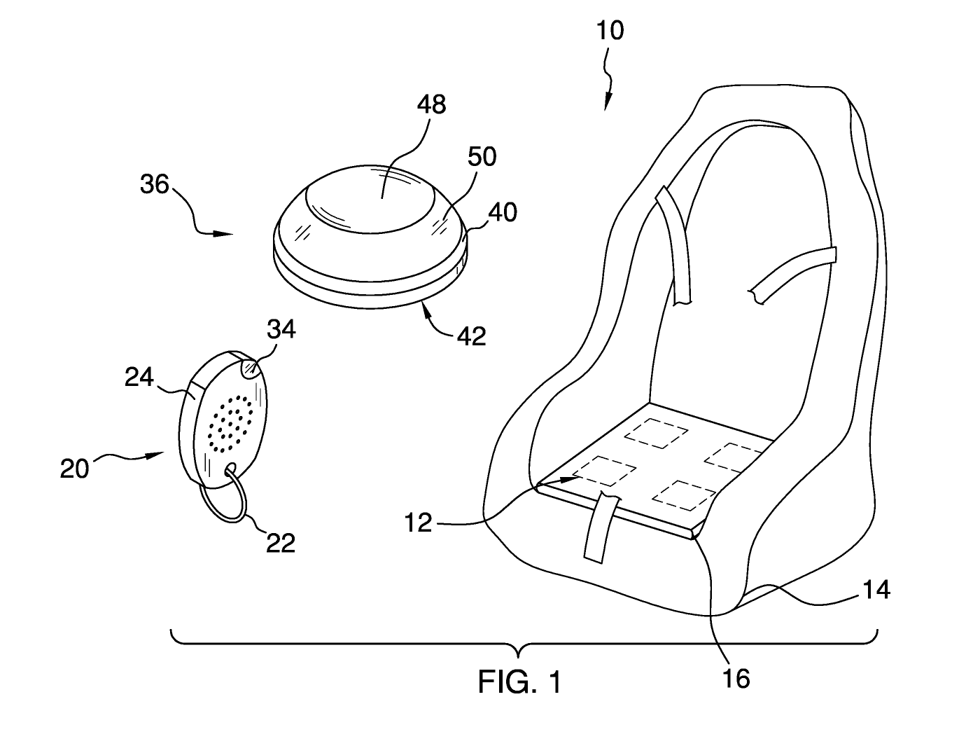

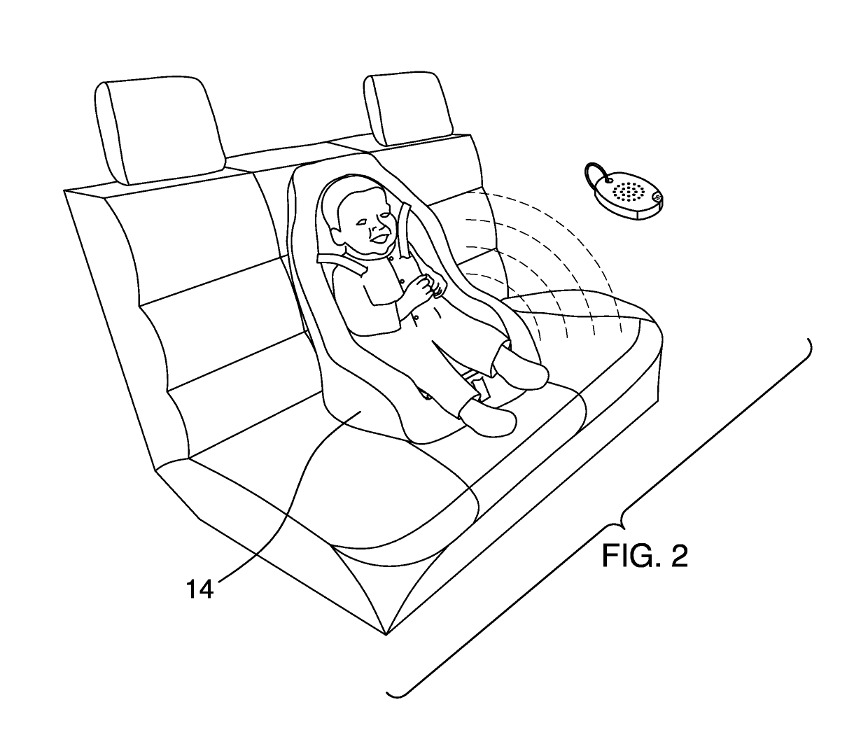

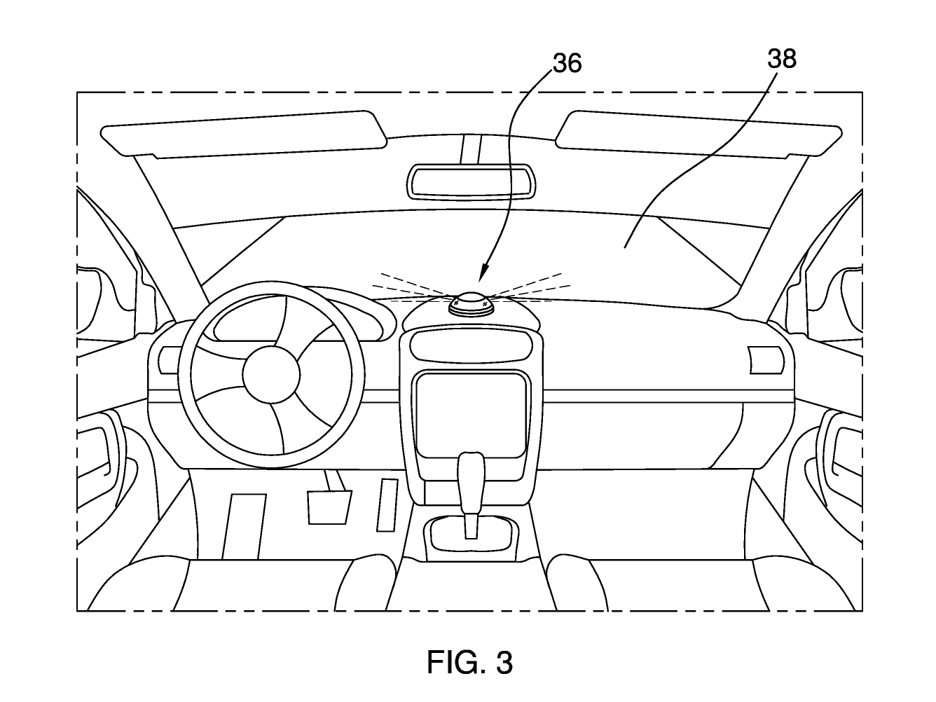

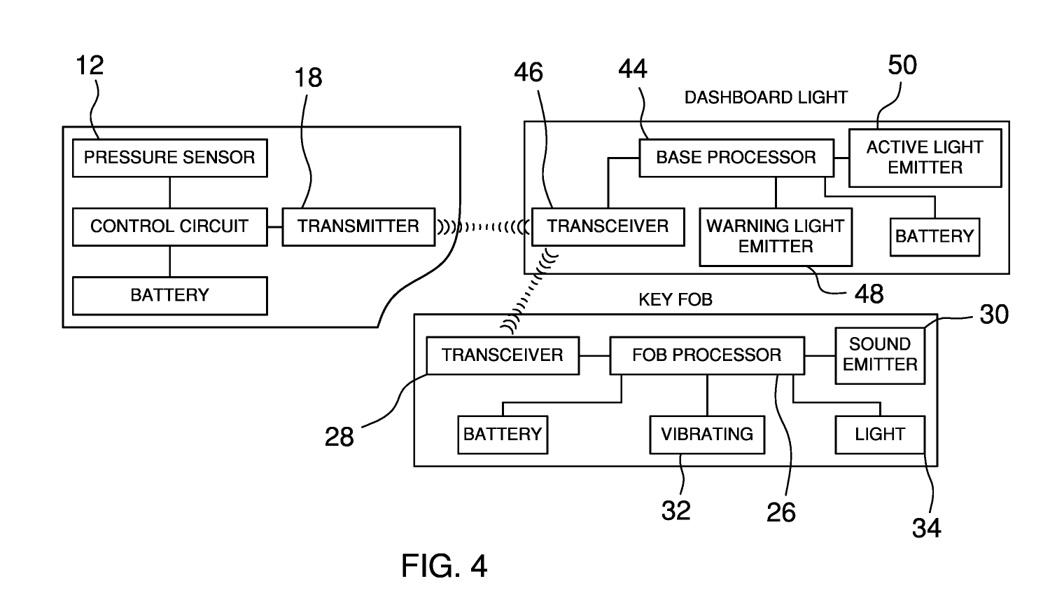

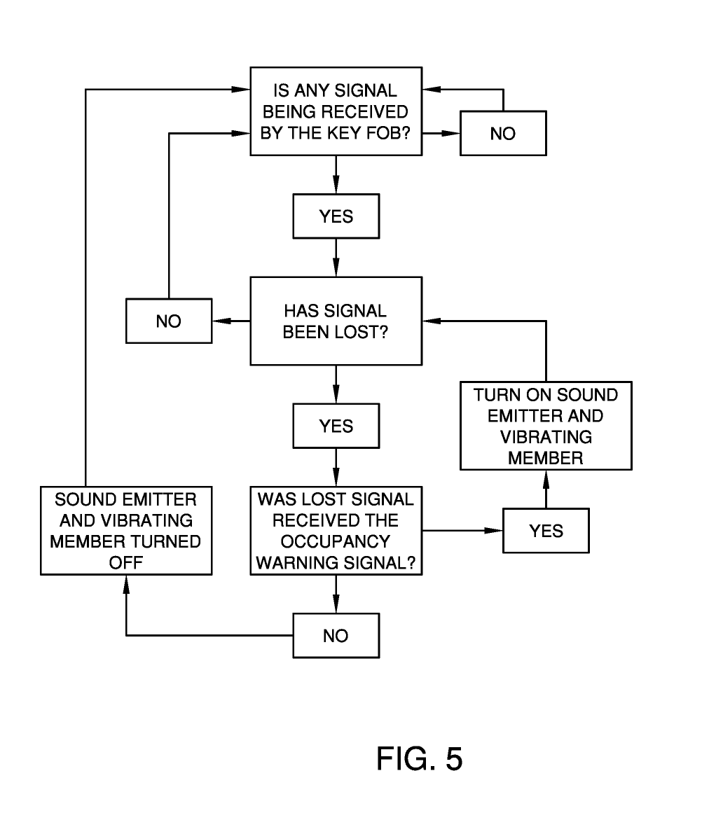

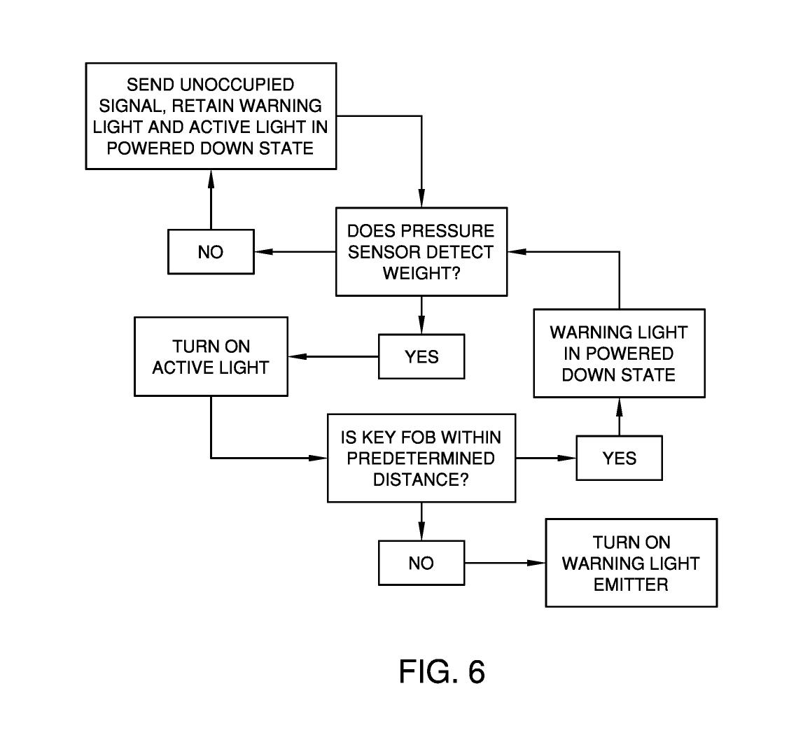

With reference now to the drawings, and in particular to FIGS. 1 through 6 thereof, a new unattended child warning device embodying the principles and concepts of an embodiment of the disclosure and generally designated by the reference numeral 10 will be described.

As best illustrated in FIGS. 1 through 6, the child vehicle occupancy warning system 10 generally comprises a pressure sensor 12 configured for detecting a weight of at least 3.0 bs and generally greater than 5.0 lbs positioned thereon. The pressure sensor 12 is configured to be positioned on a child car seat 14 and detects the weight of a child on the child car seat 14. It should be understood that the pressure sensor 12 may be positioned within the child car seat 14 or may be a pad 16 or similar structure positioned on the child car seat 14. A transmitter 18 is electrically coupled to the pressure sensor 12 and sends a weight detection signal when the pressure sensor 12 detects the weight on the child car seat 14.

A key fob 20 is provided and may include a conventional ring 22 for holding one or more keys. The key fob 20 includes a fob housing 24 having a fob processor 26 positioned therein. A fob transceiver 28 is mounted in the fob housing 24 and is electrically coupled to the fob processor 26. The fob transceiver 28 may comprised a conventional transceiver though other means of sending and receiving signals such as passive RFID type assemblies may also be utilized particularly for transmitting a location of the key fob proximate other elements of the system 10. A sound emitter 30 is mounted in the fob housing 24 and is electrically coupled to the fob transceiver 28. A vibrating member 32 may also be mounted in the fob housing 24 and electrically coupled to the fob transceiver 28. A light 34 may be mounted on the fob housing 24 and electrically coupled to the fob transceiver such that the light 34 is turned on when the vibrating member 32 or sound emitter 30 are turned on.

A base unit 36 is configured for being positioned on a dashboard 38 of a vehicle. The base unit 36 includes a base housing 40 having a bottom surface 42 comprising an anti-slip material such as an elastomeric material. Attachment members, such as suction cups, may be attached to the bottom surface 42. A base processor 44 is mounted in the base housing 40. A base transceiver 46 for receiving wireless signals from the transmitter 18 and sending and receiving signals with the fob transceiver 28 is electrically coupled to the base processor 44. The base transceiver 46 is positioned in the base housing 40. The base processor 44 determines when the fob transceiver 28 is beyond a predetermined distance from the base unit 36.

A warning light emitter 48 is electrically coupled to the base transceiver 46 and is mounted on the base housing 40. The warning light emitter 48 preferably has a relatively high intensity light to be easily viewable, during daytime sunlight, from a distance of greater than 100 feet and further may comprise a strobe light. An active light emitter 50 may also be electrically coupled to the base transceiver 46 and is mounted on the base housing 40. The active light emitter 50 will comprise a relatively low intensity light such as not to be distracting to a driver of the vehicle but to allow the driver to see that the system 10 is operational.

In use then, generally, the active light emitter 50 is turned on when the weight detection signal is received by the base transceiver 46 and will turn off when no weight detection signal is received by the base transceiver 46. Thus, the user of the system 10 will be able to determine if the pressure sensor 12 has detected the weight, presumably a child, positioned on the child car seat 14. Once the base transceiver 46 receives the weight detection signal, that is when the pressure sensor 12 detects weight, the base transceiver 46 will emit an occupancy warning signal. Conversely, if no weight detection signal is received, the base transceiver 46 will emit an unoccupied signal. In this manner, the fob transceiver 28 will receive either the unoccupied signal or the occupancy warning signal when in wireless range of the base transceiver 46.

The base processor 44 receives a fob signal from the fob transceiver 28. The base processor 44 will turn on the warning light emitter 48 when the weight detection signal is received by the base transceiver 46 and the fob transceiver 28 is beyond the predetermined distance. The predetermined distance may be calculated by GPS with a GPS receiver built into each of the fob processor 26 and the base processor 44 such that the base processor 44 may calculate the distance between the key fob 20 and the base unit 36. However, to conserve power, it may be preferred that the predetermine distance may instead be the distance at which the base transceiver 46 no longer is in wireless communication with the fob transceiver 28. Depending on the type and power of the wireless signal being utilized, this distance may be between 5.0 feet and 50.0 feet and will typically be between 5.0 feet and 15.0 feet. Once the warning light emitter 48 is turned on, it is hoped that persons near the vehicle will see flashing light being emitted by the warning light emitter 48 and investigate to determine that a child has been left in the vehicle.

The fob processor 26 will therefore be receiving no signal, the occupancy warning signal or the unoccupied signal. If the fob processor 26 is receiving the occupancy warning signal and then receives no signal, the fob processor 26 will interpret this as the key fob 20 having moved beyond the predetermined distance. Because the fob processor 26 will therefore have last detected the occupancy warning signal subsequent to losing wireless communication with the base transceiver 46, the fob processor 26 will turn on the sound emitter 30 and the vibrating member 34 to warn the user of the system 10 that they have left the vehicle while weight was still being detected on the pressure sensor 12. However, if the fob processor 26 is receiving the unoccupied signal and then receives no signal, the fob processor 26 will interpret the condition as the key fob 20 having moved beyond the predetermined distance while no weight was positioned on the pressure sensor 12. In this condition the sound emitter 30 and vibrating member 32 will not be turned on and will remain in a powered down state.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A child seat occupancy monitoring system, said system comprising:
a pressure sensor configured for detecting a weight positioned thereon, said pressure sensor being configured to be positioned on a child car seat and detecting the weight of a child on said child car seat;
a transmitter being electrically coupled to said pressure sensor and sending a weight detection signal when said pressure sensor detects said weight on said child car seat;
a key fob including:
a fob housing;
a fob processor;
a fob transceiver being mounted in said fob housing and being electrically coupled to said fob processor;
a base unit being configured for being positioned on a dashboard of a vehicle, said base unit including:
a base housing;
a base processor being mounted in said base housing;
a base transceiver for receiving wireless signals from said transmitter and sending and receiving signals with said fob transceiver, said base transceiver being positioned in said base housing and being electrically coupled to said base processor, said base processor determining when said fob transceiver is beyond a predetermined distance from said base unit;
an active light emitter being electrically coupled to said base transceiver and being mounted on said base housing, said active light being turned on when said weight detection signal is received by said base transceiver, said active light defining a ring extending around a top of said base housing;
a warning light emitter being electrically coupled to said base transceiver and being mounted on said base housing, said warning light emitter being positioned on top of said active light emitter such that said base housing, said active light emitter, and said warning light emitter form a dome shape; and
said base processor turning on said warning light emitter when said weight detection signal is received by said base transceiver and said fob transceiver is beyond said predetermined distance.

2. The child seat occupancy monitoring system according to claim 1, wherein said pressure sensor is configured for detecting when said weight is greater than 5.0 lbs.

3. The child seat occupancy monitoring system according to claim 1, wherein:
said base transceiver emitting an occupancy warning signal when said pressure sensor detects weight;
said key fob further includes a sound emitter being mounted in said fob housing and being electrically coupled to said fob transceiver; and
said sound emitter being turned on when said fob processor last detects said occupancy warning signal and subsequently looses wireless communication with said base transceiver.

4. The child seat occupancy monitoring system according to claim 3, wherein:
said key fob further includes a vibrating member being mounted in said fob housing and being electrically coupled to said transceiver; and
said vibrating member being turned on when said fob processor last detects said occupancy warning signal and subsequently looses wireless communication with said base transceiver.

5. The child seat occupancy monitoring system according to claim 1, wherein:
said base transceiver emitting an occupancy warning signal when said pressure sensor detects weight;
said key fob further includes a vibrating member being mounted in said fob housing and being electrically coupled to said transceiver; and
said vibrating member being turned on when said fob processor last detects said occupancy warning signal and subsequently looses wireless communication with said base transceiver.

6. (canceled)

7. A child seat occupancy monitoring system, said system comprising:
a pressure sensor configured for detecting a weight greater than 5.0 lbs positioned thereon, said pressure sensor being configured to be positioned on a child car seat and detecting the weight of a child on said child car seat;
a transmitter being electrically coupled to said pressure sensor and sending a weight detection signal when said pressure sensor detects said weight on said child car seat;
a key fob including a ring configured for holding a key, said key fob including:
a fob housing;
a fob processor;
a fob transceiver being mounted in said fob housing and being electrically coupled to said fob processor;
a sound emitter being mounted in said fob housing and being electrically coupled to said fob transceiver;
a vibrating member being mounted in said fob housing and being electrically coupled to said transceiver;
a base unit being configured for being positioned on a dashboard of a vehicle, said base unit including:
a base housing;
a base processor being mounted in said base housing;
a base transceiver for receiving wireless signals from said transmitter and sending and receiving signals with said fob transceiver, said base transceiver being positioned in said base housing and being electrically coupled to said base processor, said base processor determining when said fob transceiver is beyond a predetermined distance from said base unit;
a warning light emitter being electrically coupled to said base transceiver and being mounted on said base housing;
an active light emitter being electrically coupled to said base transceiver and being mounted on said base housing, said active light defining a ring extending around a top of said base housing, said warning light emitter being positioned on top of said active light emitter such that said base housing, said active light emitter, and said warning light emitter form a dome shape;
said active light being turned on when said weight detection signal is received by said base transceiver;
said base transceiver emitting an unoccupied signal when said weight detection signal is not received by said base transceiver;
said base transceiver emitting an occupancy warning signal when said pressure sensor detects weight;
said base processor turning on said warning light emitter when said weight detection signal is received by said base transceiver and said fob transceiver is beyond said predetermined distance;
said sound emitter being turned on when said fob processor last detects said occupancy warning signal and subsequently looses wireless communication with said base transceiver; and
said vibrating member being turned on when said fob processor last detects said occupancy warning signal and subsequently looses wireless communication with said base transceiver.
